(19) United States
(12) Patent Application Publication
(10) Pub. No.: US 2023/0267627 A1
(43) Pub. Date: Aug. 24, 2023

(54) TRANSFERRING ALIGNMENT INFORMATION IN 3D TOMOGRAPHY FROM A FIRST SET OF IMAGES TO A SECOND SET OF IMAGES

(71) Applicant: Carl Zeiss SMT GmbH, Oberkochen (DE)

(72) Inventors: Thomas Korb, Schwaebisch Gmuend (DE); Alex Buxbaum, San Ramon, CA (US); Eugen Foca, Ellwangen (DE); Jens Timo Neumann, Aalen (DE); Amir Avishai, Pleasanton, CA (US); Dmitry Klochkov, Schwaebisch Gmuend (DE)

(21) Appl. No.: 18/310,163

(22) Filed: May 1, 2023

Related U.S. Application Data
(63) Continuation of application No. PCT/EP2021/025402, filed on Oct. 14, 2021.
(60) Provisional application No. 63/109,447, filed on Nov. 4, 2020.

(51) Int. Cl. G06T 7/38; G06T 7/33; G06T 7/73; G06T 11/00

(52) U.S. Cl. CPC G06T 7/38; G06T 7/33; G06T 7/73; G06T 11/003; G06T 2207/10072; G06T 2207/10061; G06T 2207/30148

(57) ABSTRACT

The present disclosure provides a method of transferring alignment information from a first set of images to a second set of images, a respective computer program product and a respective inspection device. A first set of cross-section images in a first imaging mode is obtained, the first cross-section images being taken at times Tai. A second set of cross-section images in a second imaging mode is obtained, the second cross-section images being taken at times Tbj, the times Tbj differing from the times Tai. Obtaining the first and second sets of cross-section images comprises subsequently removing a cross-section surface layer of a sample to make a new cross-section accessible for imaging, and imaging the new cross-section of the sample in the first imaging mode or in the second imaging mode. Switching is performed between the first and second imaging modes while obtaining the first and second sets of cross-section images.

### CROSS-REFERENCE TO RELATED APPLICATIONS

The present application is a continuation of, and claims benefit under 35 USC 120 to, international application PCT/EP2021/025402, filed Oct. 14, 2021, which claims benefit under 35 USC 119 of U.S. Provisional Application No. 63/109,447, filed Nov. 4, 2020. The entire disclosure of these applications are incorporated by reference herein.

### FIELD

The present disclosure relates to the generation of 3D tomography data out of 2D slices in a slice and image approach. For example, the present disclosure relates to a method of transferring alignment information from a first set of images to a second set of images for example for obtaining a 3D volume image of a sample, for example an integrated semiconductor sample. Furthermore, the disclosure relates to a corresponding computer program product and a corresponding inspection device.

### BACKGROUND

A common way to generate 3D tomographic data from samples on nm scale, for example from semiconductor samples on nm scale, is the so-called slice and image approach elaborated for example by a dual beam device. In such an apparatus, two particle optical systems are typically arranged at an angle. The first particle optical system can be a scanning electron microscope (SEM) or another charged particle microscope like e.g. a Helium ion microscope (HIM). The second particle optical system can be a focused ion beam optical system (FIB), using for example gallium (Ga) ions. A focused ion beam (FIB) of Ga ions is used to cut off layers at an edge of a sample slice by slice (“milling”) and every cross-section is imaged using a scanning electron microscope (SEM) or the HIM. The two particle optical systems might be oriented perpendicular or at an angle between 45° and 90°. FIG. 1 shows a schematic view of the slice and image approach: using a FIB optical column 50, with a focused ion particle beam 51 in y-direction, and scanning in x-y-plane, a thin layer from the cross-section through a semiconductor sample 10 is removed to reveal a new front surface 52 as a cross-section image plane 11. In a next step, a SEM or HIM (not shown) is used for scanning imaging the front surface of the cross-section 11. In this example, the SEM optical axis is oriented parallel to the z-direction, and the scanning imaging lines 82 in x-y-plane raster scan the cross-section image plane 11 and forms cross-section images or slices 100. By repetition of this approach through for example front surfaces 53 and 54, a sequence of 2D cross-section images 1000 through the sample in different depths is obtained. The distance dz between two subsequent image slices can be 1 nm-10 nm, but other values, for example up to 25 nm or 30 nm, are also possible depending on the concrete application. From the sequence of these 2D cross-section images 1000, a 3D image of the integrated semiconductor structure can be reconstructed. Other samples than integrated semiconductor samples can also be investigated; however, investigating integrated semiconductor samples can be relatively challenging.

With the finer detail and the smaller feature sizes in modern integrated circuits, the reconstruction of the 3D tomographic image can involve several challenges. Lateral stage drifts or drifts of the SEM column may cause offsets in the lateral positions of the structures from slice to slice. Variations in the FIB cutting rate may cause the intersection surfaces to be at varying distances. Image distortions may lead to cross-section images with for example pin-cushion or shear distortion. FIG. 2 shows an example of a reconstruction of x-z-slices from a sequence of x-y cross-section images. For the sake of simplicity, only three cross-section images 100.1, 100.2, 100.3 at z-positions z1, z2 and z3 are shown of the sequence of 2D cross-section images 1000. The random stage or SEM drifts lead to artificially enhanced line edge roughness of the metal lines 101 which are extended in z direction or large variations of the width of the metal lines 102 which are extended in parallel to the z-direction.

It is a common method to derive the lateral position of each slice as well as the distance from layer to layer with the help of so-called fiducials. U.S. Pat. No. 9,633,819 B2 discloses an alignment method based on guiding structures (“fiducials”) exposed to the top of the sample. FIGS. 3A and 3B illustrate the alignment with fiducials. As will be explained below in more detail, marker structures 21 and 22 are formed into a deposition material on top of the sample perpendicular to the direction of the cross-sections before the FIB cutting of intersections 52, 53 and 54 begins. After slicing and imaging the cross-sections, each cross-section image contains also cross-section image segments 25 and 27 of the fiducials or alignment markers 21 and 22. The first central markers 21 are used to perform the lateral alignment amongst the slices while the distance between the two outer, second markers 22, leading to two cross-section image segments 27, is used to calculate the distance between each slice.

However, imaging the guiding structures or fiducials together with the structure of interest can have several drawbacks.

First, to get an acceptable alignment it may be sufficient to image the fiducials with a bigger pixel size than the structure of interest. The fiducials can for example be imaged with 4 nm pixel size or even bigger while the structure of interest involves for example a pixel size of 2 nm or less. Since it is generally not possible to accommodate both into one image from one scan, both the structure of interest and fiducials are often imaged with 2 nm pixel size potentially leading to a drop of the throughput. To give an example, imaging one pixel with 2 nm pixel size can take up to several minutes, for example one or two minutes or even longer.

Second, it is sometimes desirable to get a small region with small pixel size, but on the other hand to have some more coarse overview image showing the surroundings.

Third, the optimal imaging conditions for the structure of interest may be contradictory to the optimal imaging conditions for the fiducials and one may have to compromise on both to find common imaging conditions—if this is possible at all. Since finally the structure of interest is desirably the best this can be a relatively bad compromise on the tool's imaging performance eventually.

It is suggested in the art to take two images with different imaging conditions right after one another. This approach is known as “FIBICS key frame approach” and is described in US 2014/0226003 A1. According to this approach, a first cross-section image (“key frame image”) is obtained with a first imaging pixel size wherein this first cross-section image comprises segments of fiducials in addition to a structure of interest. Directly afterwards, a second cross-section image is obtained with a second imaging pixel size which is suited to show the structure of interest in the cross-section image in good detail. The position of the fiducial in the first cross-section image is determined and therefore the position of the structure of interest is also in general known in both the first cross-section image and the second cross-section image. Switching between these imaging conditions is carried out several times.

However, switching between imaging conditions according to this approach can have drawbacks. The alignment fiducials in the key frame image are imaged at another time instance than the structure of interest in the second cross-section image(s). Especially if the milling continues during imaging this can lead to systematic errors in the proper creation of the 3D tomography data for the structure of interest.

### SUMMARY

The present disclosure seeks to improve the generation of 3D tomographic data from samples on nm scale.

The present disclosure also to improve the alignment of cross-section images when generating a 3D tomographic data set (performing image registration).

The present disclosure further seeks to transfer alignment information from one set of images to another set of images which may be taken at different time instances, with different pixel sizes and/or with other sensors.

According to a first aspect, the disclosure is directed to a method of transferring alignment information in 3D tomography from a first set of images to a second set of images, comprising the following steps:
obtaining a first set of cross-section images in a first imaging mode, the first cross-section images being taken at times Tai;
obtaining a second set of cross-section images in a second imaging mode, the second cross-section images being taken at times Tbj, the times Tbj differing from the Times Tai; wherein obtaining the first and second set of cross-section images comprises subsequently removing a cross-section surface layer of a sample, for example using a focused ion beam, to make a new cross-section accessible for imaging, and imaging the new cross-section of the sample in the first imaging mode or in the second imaging mode, for example with a charged particle beam, wherein switching is performed between the first imaging mode and the second imaging mode during obtaining the first and the second set of cross-section images;
determining alignment information included in the cross-section images of the first set; and
transferring the alignment information from the cross-section images of the first set to the cross-section images of the second set, wherein transferring the alignment information comprises time-dependent interpolation of the alignment information.

According to an embodiment, the area or part of the sample that is imaged in the first imaging mode fully or partly includes the area or part of the sample that is imaged in the second imaging mode. However, this is not necessarily the case. In an example, in both imaging modes a structure of interest is imaged; however, the structure of interest is imaged in high resolution only in the second imaging mode, but not in the first imaging mode. Still, the imaging conditions in the first imaging mode are generally sufficient for determining alignment information, for example based on fiducials. In an example, fiducials are imaged in the first imaging mode, but are not imaged in the second imaging mode; furthermore, the structure of interest is imaged in the second imaging mode, only. Within the description of the present disclosure, the term “cross section image” has to be interpreted in broad sense: A cross section image can be a full cross section image. Alternatively, a cross section image can be only a part or a region of a full cross section image. In an example, a full cross section image can comprise two different cross section images which both show different parts or regions of the sample imaged at different times. So a first part of the sample is imaged in a first imaging mode and a second part is imaged in a second imaging mode; this kind of imaging/switching between the two different imaging modes can be carried out during one raster scan with the particle beam or during different (for example subsequent) raster scans (one raster scan is for example a movement of the particle beam over the sample from a top left corner to a bottom right corner).

The term “alignment information” within this patent application is used synonymously with the term “positional information”. However, the term “alignment information” further indicates the intended use of the information, namely for alignment purposes.

According to embodiments of the disclosure, the first cross-section images are taken at times Tai and the second cross-section images are taken at times Tbj wherein the times Tai differ from the times Tbj. In other words, the cross-section images of the first set are taken at different times than the cross-section images belonging to the second set. The index a indicates the first set and the index i labels a concrete cross section image of the first set of cross section images. Similarly, the index b indicates the second set and the index j labels a concrete cross section image of the second set of cross section images. It is possible that the first set of cross-section images and the second set of cross-section images comprise the same number of cross-section images, respectively; however, it is also possible that this is not or at least not precisely the case. It is possible that the times Tai and the times Tbj form a regular “time pattern” in their entirety; however, it is also possible that this is not the case. The first set of cross-section images can, for example, comprise 100, 200, 300 or 400 or even more cross-section images, so can the second set of cross-section images. It is, however, optional for the number of cross-section images of the second set to be at least the number of cross-section images of the first set. For example, the number of cross-section images building the second set can be identical to the number of cross-section images building the first set or the number of cross-section images of the second set can be twice or three times the number of cross-section images of the first set.

According to embodiments of the disclosure, switching is performed between the first imagining mode and the second imaging mode during obtaining the first and the second set of cross-section images. This means that it is excluded that the first set of cross-section images is fully obtained and then, afterwards, the second set of cross-section images is fully obtained. Instead, switching from the first imaging mode to the second imaging mode as well as switching back from the second imaging mode to the first imaging mode is carried out at least once, optionally several times, for example hundreds of times.

According to an embodiment, the first imaging mode differs from the second imaging mode. The difference can be in the pixel size, in other particle optical parameters for imaging and/or in the detection system/detection method for obtaining the images. It is, however, also possible that the first imaging mode and the second imaging mode are technically identical, but that in the first imaging mode a different region or structure of the sample is imaged than in the second imaging mode.

According to embodiments of the disclosure, alignment information included in the cross-section images of the first set is determined. In other words, the alignment information is obtained at known times Tai for the cross-section images of the first set. In general, the alignment information can be positional information of any type. The alignment information can comprise information about lateral alignment in the main scanning direction x and/or in the sub-scanning direction y and/or alignment information in the slicing direction z. Optionally, the directions x, y and z are orthogonal to one another, however, other coordinate systems are also possible. It is, for example, possible that alignment information included in the key frame cross-section images of the first set is determined. In these first cross-section images (for example the key frame cross-section images), alignment information, for example, in the form of positions of fiducials or fiducial segments, is measured for each marker or fiducial. Known image processing methods give the position of the positional markers in pixels, and knowing the pixel size, these positions can be translated into positions in nm. Therefore, the alignment information which is positional information is known for the cross-section images of the first set at known times Tai. In contrast thereto, alignment information possibly also included in cross-section images of the second set is not determined by a measurement. It is not even necessary that alignment information is included in the second set of cross section images. Instead, alignment information from the cross-section images of the first set can be transferred to the cross-section images of the second set. Transferring the alignment information can comprise time-dependent interpolation of the alignment information. This means that alignment information is just calculated from the measured positions/alignment information determined from the cross-section images of the first set. In other words, considering the key frame approach, alignment information can be determined from the key frame images themselves, and the alignment information determined from the key frame images can be transferred to the images of the structures of interest by applying a time-dependent interpolation. The term interpolation is defined in the mathematical sense: For given discrete data (e.g. measured values), a continuous function (the so-called interpolant) is to be found that maps this data. The function is then set to interpolate the data. The time-dependent interpolation can comprise a stepwise-continuous interpolation. Then, the continuous function is only step-wise continuous. Furthermore, the time-dependent interpolation can be carried out in one, two or three dimensions of space. It is therefore not necessarily the case that the time-dependent interpolation is carried out in all three dimensions of space. Examples will be described below.

In general, this time-dependent interpolation works for different slice and image workflows. The alignment information can be transferred, for example, in the continuous milling mode or in the mill-stop-image mode. These different types of milling and their respective impact on alignment transfer calculations will be further described below.

According to an embodiment, the cross-section images of the first set have a first imaging pixel size and the cross-section images of the second set have a second imaging pixel size differing from the first imaging pixel size. Additionally, or alternatively, it is possible that other parameters are different in the first imaging mode and in the second imaging mode. It is, however, also possible that other imaging parameters are the same in the first imaging mode and in the second imaging mode and that the different imaging pixel sizes are the only difference between the imaging modes. The differences in the respective pixel sizes are taken into consideration when transferring the alignment information.

According to an embodiment, the first imaging pixel size is at least twice the second imaging pixel size. It is common to define the imaging pixel size one-dimensional, for example, in terms of nanometers. For example, the first imaging pixel size can be 4 nm and the second imaging pixel size can be 2 nm. Referring to a quadratic pattern of pixels, the area of the first imaging pixels is at least four times the area of the second imaging pixels. Other definitions of the pixel size are also possible. Throughput gain according to the disclosure can become more powerful the bigger the difference between the first imaging pixel size and the second imaging pixel size is or, more generally, the more different the first imaging mode and the second imaging mode are. The method can allow for a significant speed up in imaging.

According to an embodiment, switching between the first imaging mode and the second imaging mode is carried out strictly alternatingly after obtaining each cross-section image. In this case, the sequence of images is for example Ta1, Tb1, Ta2, Tb2, Ta3, Tb3 . . . . In an example, the time interval between two subsequent time instances Tai and Tai+1 is constant within the first set of cross-section images. In an example, the time interval between two subsequent time instances Tbj and Tbj+1 is constant for each j of the second set of cross-section images. It is possible to take the second cross-section images timewise exactly in between two subsequent first cross-section images. However, this is not necessarily the case.

According to an embodiment, determining the alignment information comprises determining positions of fiducials. This is a well-known approach for determining alignment information.

According to an embodiment, the fiducials comprise a set of parallel fiducials elongating precisely in depth direction (slicing direction) and a set of non-parallel fiducials elongating obliquely to the depth direction (slicing direction). This type of fiducials is, for example, shown in US 2014/0226003 A1 and is also shown in FIG. 3A of this application. In an example, a set of parallel fiducials comprises at least two fiducials, for example, exactly two, three, four or more fiducials. A set of non-parallel fiducials elongating obliquely or inclined to the depth direction (slicing direction) can comprise exactly two fiducials which can, for example, be provided symmetrically to the depth direction (slicing direction). This geometry can allow for a simple determination of alignment information or positional information.

According to an embodiment, obtaining the first and second set of cross-section images is carried out in a continuous milling mode. In a continuous milling mode, the milling process continues during obtaining the cross-section images. There is no stop for obtaining the cross-section images. The milling rate can be chosen to be constant. For a continuous milling mode, the alignment information or the fiducial positions can be assumed to be a smooth function of time and the desired positions of the alignment markers or fiducials for the second cross-section images showing the structures of interest can be determined by time-dependent interpolation using the known positions. In an example, transferring the alignment information comprises a time-dependent interpolation of position of the fiducials for the points of time Tbj when the cross-section images of the second set are obtained based on the points of time Tai when the cross-section images of the first set are obtained. This time-dependent interpolation can take into consideration the continuous milling and therefor the thus varying positions of fiducials, but it can also take possible drifts of the stage and/or drifts of an imaging column (for example, an SEM or HIM column) into consideration. According to an example, the time-dependent interpolation is a linear interpolation. It has turned out that in many cases this relatively simple form of interpolation is sufficient for getting excellent alignment results.

According to an embodiment, the time intervals between taking two cross-section images are constant. In an example, this holds for two subsequent cross-section images of the same set, however, additionally, this can be also fulfilled for two subsequent cross-section images belonging to different sets. Applying constant time intervals can facilitate the interpolation and can also facilitate the entire image registration from a plurality of cross-section images.

According to an embodiment, the alignment information is a lateral alignment information and/or a depth alignment information. Then, the time-dependent interpolation can also refer to time-dependent lateral interpolation and/or to time-dependent depth-interpolation. The alignment information can be determined for lateral positions and for depth positions separately, for example by making reference to different fiducials. This can facilitate the data analysis and the image processing procedures.

According to an embodiment, obtaining the first and second set of cross-section images is carried out in a mill-stop-image mode. According to such a mill-stop-image mode, the process can be as follows. In a first step, milling is performed. Then, a first cross-section image is obtained when milling is paused. Subsequently, during milling is still paused, a second cross-section image of the second imaging mode is obtained. Afterwards, the milling process is continued. The milling process stops again before the next cross-section image of the first set of images is obtained and so on. In other words, no milling is carried out when obtaining both the first cross-section images or the second cross-section images. Furthermore, there is no milling in the time interval between taking a cross-section image of the first set and a corresponding cross-section image of the second set. In other words, the depth coordinate (z-direction, slicing direction) when taking a cross-section image of the first set and a cross-section image of the second set is unchanged since milling is paused. This can have consequences for the time-dependent interpolation when transferring the alignment information to the second set of cross-section images: According to an example, the time-dependent interpolation of the alignment information is a time-dependent interpolation of a lateral alignment information. According to an example, a depth alignment information is not interpolated timewise. The explanation is as follows. For a z-stacking (slicing direction) a slow drift of the stage in between the image pair acquisitions does not matter since for the z-stacking only the distance of two side fiducials is measured and transferred. The distance between two side fiducials (or obliquely or inclined arranged fiducials) is not susceptible to slow stage drifts. On the other hand, for the lateral alignment a slow stage drift can be assumed to be a continuous and slowly varying function. Therefore, lateral positional information for the alignment markers in the second set of cross section images can be calculated from a time-dependent interpolation of the known lateral positions.

According to an embodiment, the depth alignment information of the cross-section images of the first set is identically transferred to the corresponding cross-section images of the second set. Corresponding cross-section images are those cross-section images taken without any milling in between.

According to an embodiment, the method further comprises the following steps. Performing image registration of obtained cross-section images and obtaining a 3D data set. The alignment is used to correct image registration and allows for obtaining a precise 3D data set. Using this 3D data set, further analyses can be carried out.

According to a second aspect of the disclosure, the disclosure is directed to a computer program product with a program code adapted for the executing the method described in various embodiments above. The code can be written in any possible programming language and can be executed on a computer control system. The computer control system as such can comprise one or more computers or processing systems.

According to a third aspect of the disclosure, the disclosure is directed to an inspection device adapted to perform the method according to anyone of the embodiments as described above.

According to an embodiment, the semiconductor inspection device comprises: a focused ion beam device; and a charged particle operating device operating with electrons or ions and adapted for imaging of the new cross-section of the sample, wherein the focused ion beam and the electron/ion beam are arranged and operated at an angle to each other and a beam axis of the focused ion beam and of the electron/ion beam intersect each other.

According to an embodiment, the focused ion beam and the electron/ion beam form an angle of about 90° with one another.

The above described embodiments can be fully or partly combined with one another as long as no technical contradictions arise.

### BRIEF DESCRIPTION OF THE DRAWINGS

The disclosure will be even more fully understood by reference to the following drawings.

FIG. 1 is an illustration of the cross-section imaging technique.

FIG. 2 is an illustration of cross-section images and two examples of intersection images through the 3D volume image.

FIGS. 3A-3B are illustrations of the fiducial alignment process as described in prior art.

FIGS. 4A-4B are illustrations of an alignment information transfer in continuous milling mode.

FIGS. 5A-5B are illustrations of an alignment information transfer in a mill-stop-image mode.

### DETAILED DESCRIPTION

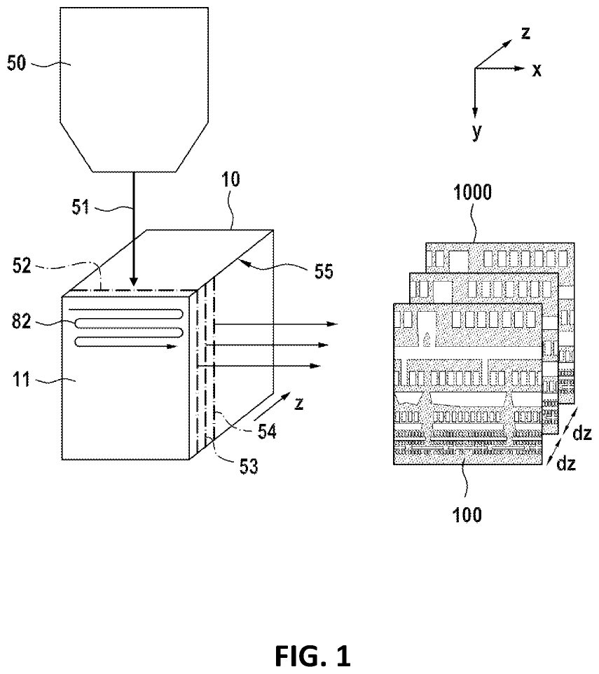

FIG. 1 shows a schematic view of the cross-section image approach to obtain a 3D volume image of an integrated semiconductor sample. With the cross-section approach, three-dimensional (3D) volume image acquisition is achieved by a “step and repeat” fashion. First, the integrated semiconductor sample is prepared for the subsequent cross-section image approach by methods known in the art. Throughout the disclosure, “cross-section image” and “slice” will be used as synonyms. Either a groove is milled in the top surface of an integrated semiconductor to make a cross-section approximately perpendicular to the top surface accessible, or an integrated semiconductor sample 10 of block shape is cut out and removed from the integrated semiconductor wafer. This process step is sometimes referred to as “lift-out”. In a step, a thin surface layer or “slice” of material is removed. For sake of simplicity, the description is shown at such a block shaped integrated semiconductor sample 10, but the disclosure is not limited to block shaped samples 10. This slice of material may be removed in several ways known in the art, including the use of a focused ion beam milling or polishing at glancing angle, but occasionally closer to normal incidence by focused ion beam (FIB) 50. For example, the focused ion beam 51 is scanned along direction x to form a cross-section 52. As a result, a new cross-section surface 11 is accessible for imaging. In a subsequent step, the newly accessible cross-section surface layer 11 is raster scanned by a charged particle beam (CPB), such as a scanning electron microscope (SEM) or a FIB (not shown). The imaging system optical axis can be arranged to be parallel to the z-direction, or inclined at an angle to the z-direction. CPB systems have been used for imaging small regions of samples at high resolution of below 2 nm. Secondary as well as backscattered electrons are collected by a detector (not shown) to reveal a material contrast inside of the integrated semiconductor sample, and visible in the cross-section image 100 as different grey levels. Metal structures generate brighter measurement results. The surface layer removal and the cross-section image process are repeated through surface 53 and 54 and further surfaces at equal distance, and a sequence of 2D cross-section images 1000 through the sample in different depths is obtained so as to build up a three-dimensional 3D dataset. The representative cross-section image 100 is obtained by measurements of a commercial Intel processor integrated semiconductor chip with 14 nm technology.

With the method, at least a first and second cross-section images includes subsequently removing a cross-section surface layer of the integrated semiconductor sample, for example with a focused ion beam, to make a new cross-section accessible for imaging, and imaging the new cross-section of the integrated semiconductor sample for example with a charged particle beam. From the sequence of these 2D cross-section images 1000, a 3D image of the integrated semiconductor structure can be reconstructed. The distance dz of the cross-section images 100 can be controlled by the FIB milling or polishing process and can be between 1 nm and 10 nm, for example about 3-5 nm, but other values are also possible depending on the concrete application.

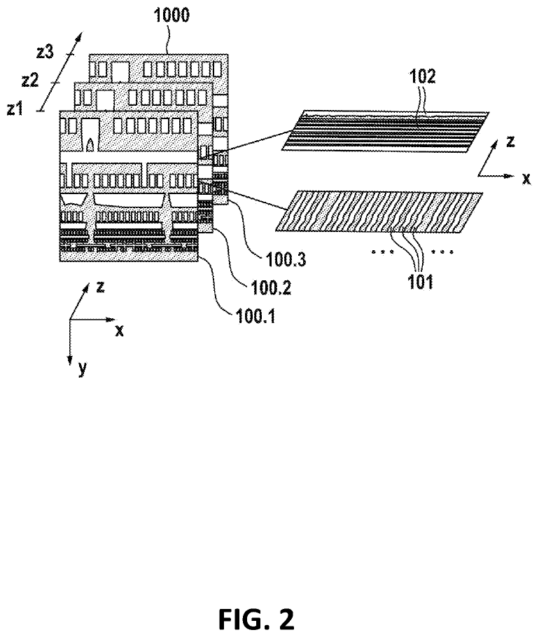

FIG. 2 shows an example of two x-z-intersection images from the reconstructed 3D volume image or 3D data set obtained from a sequence of N=400 image slices or cross-section images 1000 obtained in x-y-direction, and spaced in z-direction by distance dz. For sake of simplicity, only three cross-section images 100.1, 100.2, 100.3 are illustrated. The random stage or SEM drifts between acquisition of the N=400 image slices lead to artificially enhanced line edge roughness in z-direction, visible in the metal lines 101 extended in z-direction, or large variations of the widths of metal lines 102, oriented perpendicular to the z-direction.

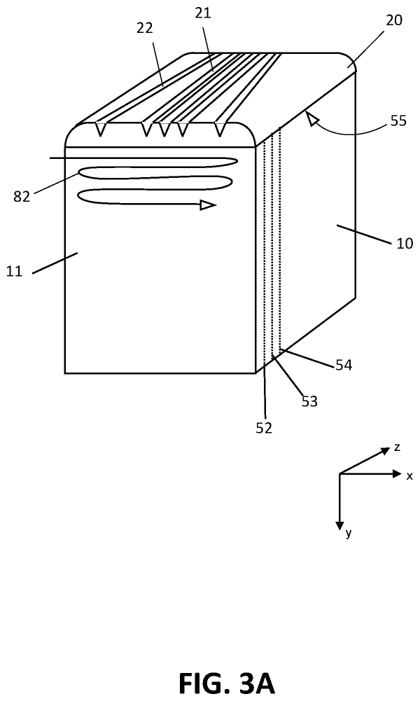

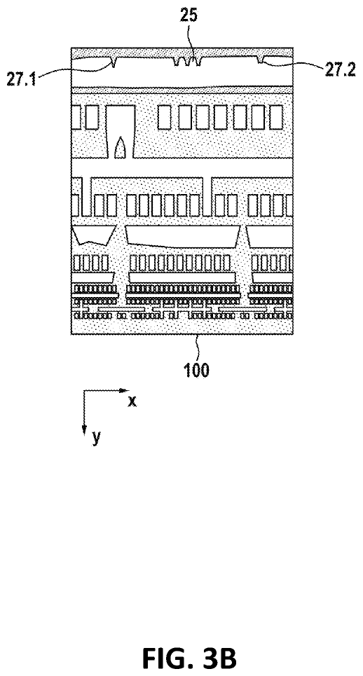

FIGS. 3A-3B illustrate the alignment with fiducials, according to prior art. Illustrated in FIG. 3A, a marker structure or fiducials are formed on top of the sample perpendicular to the direction of the cross-sections before the FIB cutting of intersections begins. For the marker structure, first a material 20 is deposed on the top surface 55 of the integrated semiconductor sample. In this material, alignment marks such as parallel lines 21 and inclined lines 22 are formed by FIB processing. After slicing and imaging the cross-section 11 by raster scanning along raster scanning lines 82, each cross-section image 100 contains also a cross-section image segment of the fiducials or alignment markers. Illustrated in FIG. 3B is a representative cross-section 100. The central markers 21 are visible via their cross-section image segments 25 and are used to perform the lateral alignment in x-direction and in y-direction amongst the slices; however, the alignment in y-direction is normally less accurate. The distance between the two cross-section image segments 27 of the two outer makers 22 is used to calculate the distance dz between each slice.

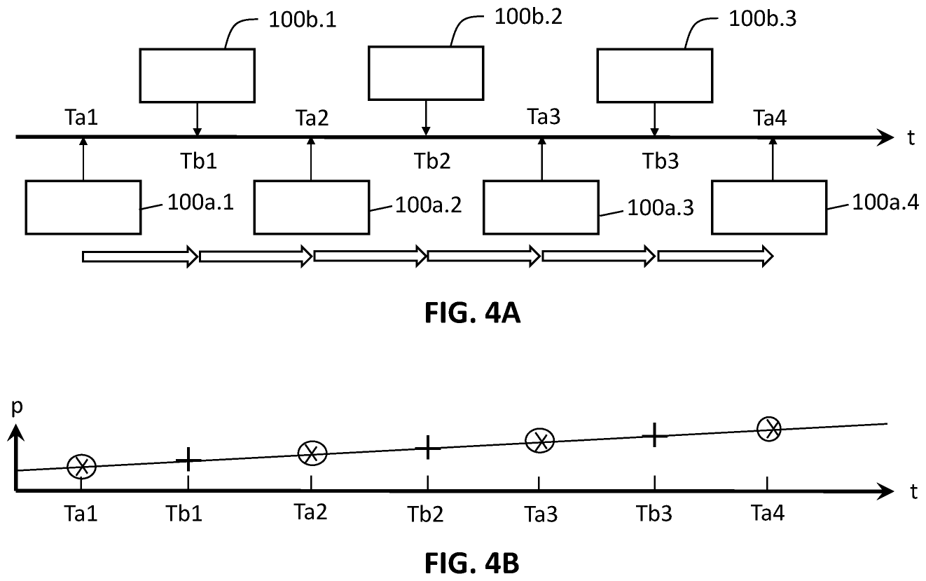

FIGS. 4A-4B illustrate an alignment information transfer in a continuous milling mode: FIG. 4A indicates the continuous milling mode by the plurality of arrows at the bottom of the figure. There is no stop in milling. Furthermore, the corresponding time axis t is depicted. At a plurality of times (time instances), cross-section images 100 are obtained: At times Ta1, Ta2, Ta3 and Ta4 cross-section images 100a.1, 100a.2., 100a.3, and 100a.4 are obtained. These cross-section images 100a.1, 100a.2. 100a.3, and 100a.4 belong to the first set of cross section images and are obtained in a first imaging mode. According to this example, the cross-section images 100a.1, 100a.2. 100a.3, and 100a.4 have a comparatively big pixel size, for example 4 nm, 6 nm, 8 nm or bigger. The imaged area comprises fiducials and alignment information is determined from these cross-section images 100a.1, 100a.2. 100a.3, and 100a.4 of the first set. For example, the position of a fiducial or the positions of a plurality of fiducials 21, 22 is determined in each of the cross-section images 100a.1, 100a.2. 100a.3, and 100a.4. Known image processing methods give the position of the fiducials or positional markers in pixels. Knowing the pixel size in the first imaging mode allows for translating/determining the positions in nanometers.

In the presented example, cross-section images 100b.1, 100b.2 and 100b.3 are imaged at times (time instances) Tb1, Tb2 and Tb3. These cross-section images 100b.1, 100b.2, 100b.3 belong to the second set of cross section images and are obtained in a second imaging mode differing from the first imaging mode. According to this example, the cross-section images 100b.1, 100b.2 and 100b.3 have a comparatively small pixel size, for example 2 nm, 1 nm or smaller. No fiducials are imaged in this second imaging mode. Instead, the imaging conditions in the second imaging mode are adapted to imaging a structure of interest in good resolution.

In the depicted example, the time interval ΔTa=Ta(i+1)−Tai is constant for all i. Furthermore, the time interval ΔTb=Tb(j+1)−Tbj is constant for all j. The cross-section images 100a of the first set are obtained strictly alternatingly with the cross-section images 100b of the second set.

As already explained above, positional information is determined from positional markers in the cross-section images 100a.1, 100a.2, 100a.3 and 100a.4 of the first set. FIG. 4B indicates the determined positions p at times Ta1, Ta2, Ta3 and Ta4. The position p can be the position of a marker, but this is not necessarily the case. According to an example, p is the position of a structure of interest or of a part of a structure of interest. Since marker structures 21, 22 and the structure of interest are present on the same sample, knowing the positions of the markers also allows for determining the positions of the structure of interest. The position p can be given in full space coordinates, for example px, py, pz. The position p is time dependent and is determined (measured) for times Ta1, Ta2, Ta3 and Ta4.

What is of interest now, is the position p of the structure of interest at times Tb1, Tb2 and Tb3 in the cross-section images of the second set. This position p varies for the following grounds: First, since imaging is carried out in a continuous milling mode, the depth of the sample is continuously reduced. Therefore, the depth coordinate (z-coordinate) in the slicing direction varies with time. Furthermore, there are also unwanted variations in position because of drifts of for example the stage position and/or the imaging column. Other environmental influences can also occur and can have an influence on the position p. Therefore, according to the disclosure, the position p(Tb1), p(Tb2) and p(Tb3) is determined by interpolation in time: The interpolated values are indicated in FIG. 4B by the crosses without a circle whereas the crosses inside the circles indicate measured values which provide the discrete values for the time-dependent interpolation of position p. The straight line in FIG. 4B is the interpolant which is linear in this example. Therefore, alignment information or positional information p is transferred from the first set of cross-section images 100a.1, 100a.2, 100a.3 and 100a.4 to the second set of cross-section images 100b.1, 100b.2 and 100b.3 by a time-dependent interpolation of the positional information p.

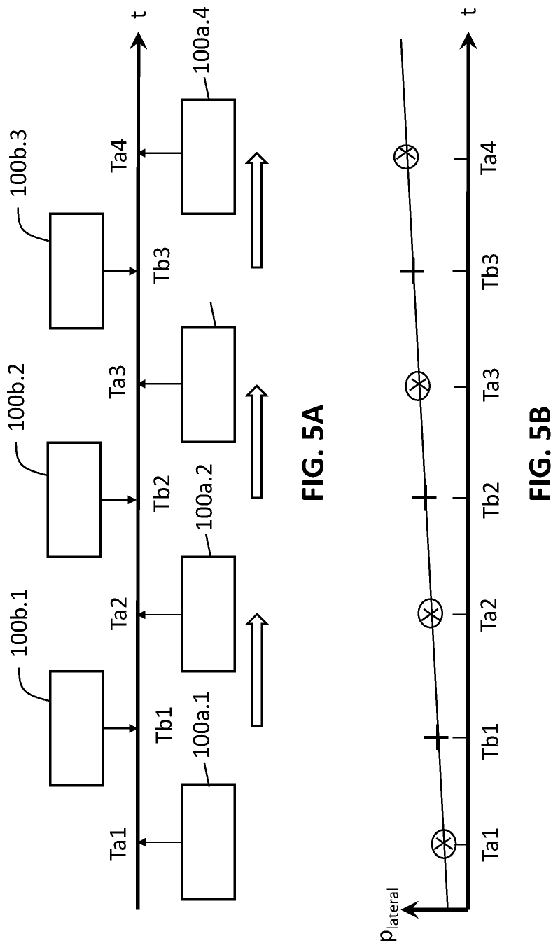

FIGS. 5A-5B illustrate an alignment information transfer in a mill-stop-image mode. In the following, only the differences between an alignment transfer in a continuous milling mode and an alignment transfer in a mill-stop-image mode will be described. The mill-stop-image mode is indicated by the interrupted plurality of arrows at the bottom of FIG. 5A. A mill-stop-image mode is characterized in that milling is paused when obtaining the cross-section images in both the first imaging mode and the second imaging mode. Furthermore, there is no milling between obtaining a cross-section image of the first set and obtaining a corresponding cross-section image of the second set. In other words, there is no change of any positional marker when comparing its position in slicing direction in a cross-section image of the first set and the corresponding cross-section image of the second set. The depth position (z-coordinate) of the positional marker or position of interest pz stays constant. Therefore, having determined the positional information pz in a cross-section image of the first set, this position pz can be identically transferred to the cross-section image of the second set (still, different pixel sizes in both sets of cross-section images have to be taken into consideration for calculating the transfer).

Though there is no change in depth direction between corresponding cross-section images, there is still a smooth and slowly varying change of position p with respect to other space coordinates, say in lateral positions px and/or py: Here, drifts of the stage and/or of an imaging column can still occur. Once again, these drift or drifts can be approximated by a smooth function dependent from time, for example by a linear function of time. Therefore, similar to the continuous milling mode, the lateral positions plates in the cross-section images of the second set can be calculated from measured data points in the cross-section images of the first set. FIG. 5B shows an example of an interpolant for illustrating lateral positional deviations: The lateral positions pₗₐₜₑᵣₐₗ at times Tb, Tb2 and Tb3 of a structure of interest in the second set of cross-section images can be determined by time-dependent interpolation.

In the present examples, a linear interpolation is shown; however, higher-order interpolations are in general also possible.

What is claimed is:

1. A method of transferring alignment information in 3D tomography from a first set of images to a second set of images, the method comprising:
obtaining a first set of cross-section images in a first imaging mode, the first cross-section images being taken at times Tai;
switching from the first imaging mode to a second imaging mode;
obtaining a second set of cross-section images in the second imaging mode, the second cross-section images being taken at times Tbj which are different from the times Tai;
determining alignment information included in the cross-section images of the first set; and
using time-dependent interpolation of the alignment information in the cross-section image of the first set to transfer the alignment information from the cross-section images of the first set to the cross-section images of the second set,
wherein obtaining the first and second sets of cross-section images comprises subsequently removing a cross-section surface layer of a sample to make a new cross-section accessible for imaging, and imaging the new cross-section of the sample in the first imaging mode or in the second imaging mode.

2. The method of claim 1, wherein the cross-section images of the first set have a first imaging pixel size, and the cross-section images of the second set have a second imaging pixel size different from the first imaging pixel size.

3. The method of claim 2, wherein the first imaging pixel size is at least twice the second imaging pixel size.

4. The method of claim 1, comprising alternating between the first and second imaging modes after obtaining each cross-section image.

5. The method of claim 1, wherein determining the alignment information comprises determining positions of fiducials.

6. The method of claim 5, wherein obtaining the first and second sets of cross-section images is performed in a continuous milling mode.

7. The method of claim 6, wherein transferring the alignment information comprises a time-dependent interpolation of positions of the fiducials for the points of time Tbj when the cross-section images of the second set are obtained based on the points of time Tai when the cross-section images of the first set are obtained.

8. The method of claim 7, wherein the time-dependent interpolation is a linear interpolation.

9. The method of claim 8, wherein time intervals between taking two cross-section images are constant.

10. The method of claim 8, wherein the alignment information comprises a member selected from the group consisting of lateral alignment information and depth alignment information.

11. The method of claim 5, wherein obtaining the first and second sets of cross-section images is performed in a mill-stop-image mode.

12. The method of claim 11, wherein transferring the alignment information comprises a time-dependent interpolation of positions of the fiducials for the points of time Tbj when the cross-section images of the second set are obtained based on the points of time Tai when the cross-section images of the first set are obtained.

13. The method of claim 12, wherein the time-dependent interpolation comprises a linear interpolation.

14. The method of claim 13, wherein the time intervals between taking two cross-section images are constant.

15. The method of claim 13, wherein the time-dependent interpolation of the alignment information is a time-dependent interpolation of lateral alignment information.

16. The method of claim 15, wherein depth alignment information is not interpolated.

17. The method of claim 16, wherein the depth alignment information of the cross-section images of the first set is identically transferred to the corresponding cross-section images of the second set.

18. The method of claim 5, wherein the fiducials comprise a set of parallel fiducials elongating in a depth direction and a set of non-parallel fiducials elongating obliquely to the depth direction.

19. The method of claim 1, further comprising:
image registering obtained cross-section images; and
obtaining a 3D data set.

20. One or more machine-readable hardware storage devices comprising instructions that are executable by one or more processing devices to perform operations comprising the method of claim 1.

21. A system comprising:
one or more processing devices; and
one or more machine-readable hardware storage devices comprising instructions that are executable by the one or more processing devices to perform operations comprising the method of claim 1.

22. The system of claim 21, further comprising:
a focused ion beam device; and
a charged particle device configured to provide charged particles to image the new cross-section of the sample.
